(19) United States
(12) Patent Application Publication
(10) Pub. No.: US 2024/0393428 A1
(43) Pub. Date: Nov. 28, 2024

(54) METHOD AND DEVICE FOR PROCESSING SIGNALS

(71) Applicant: H-NEXT GMBH, Erlangen (DE)

(72) Inventor: Oliver HEID, Erlangen (DE)

(73) Assignee: H-NEXT GMBH, Erlangen (DE)

(21) Appl. No.: 18/692,125

(22) PCT Filed: Sep. 14, 2022
(86) PCT No.: PCT/EP2022/075479

§ 371 Date: Mar. 14, 2024

(30) Foreign Application Priority Data
Sep. 14, 2021 (DE) 10 2021 123 693.2

(51) Int. Cl. G01S 7/35; G01S 7/536; G01S 13/02

(52) U.S. Cl. CPC G01S 7/354; G01S 7/536; G01S 13/0209

(57) ABSTRACT

A signal processing system includes a signal supply device which is configured to output an analytically complex, bandwidth-limited signal, and a signal processing device which includes a frequency setting device and an interpolation device. The frequency setting device is configured to specify a reference frequency lying within the bandwidth of the analytical signal. The reference frequency determines a constant reference phase advance per unit distance of successive sample values, or data point values, of the analytical signal. The interpolation device is configured to generate at least one value which interpolates the data point values at a specified location.

### CROSS-REFERENCE TO RELATED APPLICATIONS

This application is a National Stage Application of PCT/EP2022/075479, filed Sep. 14, 2022, which claims benefit of priority to German Patent Application No. 102021123693.2, filed Sep. 14, 2021, and which applications are incorporated herein by reference. To the extent appropriate, a claim of priority is made to each of the above disclosed applications.

### FIELD OF THE INVENTION

The invention relates to a method for processing signals, for example radar signals. The invention further relates to a device which is configured to process bandwidth-limited signals.

### PRIOR ART

EP 1 041 398 B1 discloses a radar device using digital beamforming technology. The radar device includes a signal processing circuit that forms beams consisting of components of beat signals and corresponding to predetermined angular directions in the radar detection range. The signal processing circuit subjects the beat signals twice to a complex Fourier transformation, wherein distance and speed information is to be obtained in the time domain and angle information in the spatial domain.

Methods of beamforming in sonar technology are described, for example, in U.S. Pat. No. 4,170,766 A. Beamforming is based on a set of signals obtained using an array of sonar transducers.

WO 2018/202257 A1 discloses a radar system with monitoring of the frequency position of a sequence of similar transmission signals. The radar system generates a sequence of transmission signals modulated in the transmission frequency and is intended for detecting the surroundings of a motor vehicle that offers driver assistance.

EP 0 050 384 A1 deals with the suppression of interference signals coming from various sources in a pulse radar receiver, aimed at eliminating interference signals. A radar receiver described in EP 0 050 384 A1 comprises a main channel and a number of auxiliary channels and is configured to receive signals which represent a superposition of signals emanating from a target object and interference signals. Signal processing includes digitization of signals in both the main channel and the auxiliary channels, wherein, weighting factors are determined during the processing of the signals, among other things.

A method for estimating the frequency of a time signal is known from WO 99/38018 A1. As part of this process, a discrete Fourier transform (DFT) is carried out. Interpolation takes place between data points of the DFT spectrum. A Hamming window is to be used for filtering. According to WO 99/38018 A1, interpolation should be carried out using a mathematically closed solution.

DE 10 2012 202 339 A1 discloses a method and a device for suppressing a received signal superimposed with noise. In this case, a squelch signal is to be determined using a Hilbert transformation.

Further information on signal processing in radar and sonar technology can be found in the following publications:
Ronald A. Mucci: A Comparison of Efficient Beamforming Algorithms, IEEE Transactions on Acoustics, Speech, and Signal Processing, Vol. ASSP-32, No. 3, June 1984
Roger G. Pridham et al.: Digital Interpolation Beamforming for Low-Pass and Bandpass Signals, Proceedings of the IEEE, Vol. 67, No. 6, June 1979
William C. Knight et al.: Digital Signal Processing for Sonar, Proceedings of the IEEE, Vol. 69, No. 11, November 1981
Timo I. Laakso et al.: Splitting the Unit Delay, IEEE Signal Processing Magazine, January 1996
Ging-Shing Liu and Che-Ho Wei: A New Variable Fractional Sample Delay Filter with Nonlinear Interpolation, IEEE Transactions on circuits and systems-II. Analog and digital signal processing, Vol. 39, No. 2, February 1992

### SUMMARY OF THE INVENTION

The invention is based on the object of specifying methods that have been further developed compared to the prior art for processing time-discretely sampled frequency band-limited signals, in particular aimed at avoiding errors that accumulate over time or other operational in-accuracies as well as a particularly favorable ratio between effort and achievable precision.

The embodiments and advantages of the invention explained below in connection with the device, that is to say, the signal processing system, also apply correspondingly to the signal processing method and vice versa.

The signal processing method assumes the provision of an analytically complex, band-width-limited signal and comprises the following steps:
specifying a reference frequency within the bandwidth of the signal mentioned,
detecting data point values of the signal mentioned, wherein a distance between successive data point values is given by a constant reference phase advance predetermined by the reference frequency,
generating at least one interpolation value, typically a plurality of interpolation values, at a predetermined point between successive data point values.

The interpolations with which interpolation values are obtained are carried out starting from measured values yₖ using the following formula: y(x)

$$y ( x ) = {z}_{0}^{x} {\sum }_{k} w ( x - k ) {z}_{0}^{- k} {y}_{k} ,$$

where z₀=e^{1ω}^{₀}^{τ} denotes a unit rotator, w denotes a weighting factor, k denotes a natural number, namely the number of data point values, and r denotes the sampling step size.

Depending on the number of data points, interpolations of different orders can be carried out. If there is an even number of data points, which is associated with an odd order of the interpolation, then x, which determines the position of the interpolated value between two data points, is between zero and one. Otherwise, that is, if there is an odd number of data points, x, that is, the index offset, is in the interval between −½ and +½.

If the interpolation is a linear interpolation, this can be done in particular using the formula

$${y}_{x} = ( ( 1 - x ) {y}_{0} + x {z}_{0}^{- 1} {y}_{1} ) {z}_{0}^{x} \qquad ( I )$$

In the case of a quadratic interpolation, this can be done in particular using the formula

$${y}_{x} = \{ \frac{{x}^{2} - x}{2} {z}_{0}^{+ 1} {y}_{- 1} + ( 1 - {x}^{2} ) {y}_{0} + \frac{{x}^{2} + x}{2} {z}_{0}^{- 1} {y}_{1} \} {z}_{0}^{x} \qquad ( II )$$

In this case, the calculation is made using the weighting factors

$$w ( x + 1 ) = \frac{{x}^{2} - x}{2} ;$$

$$w ( x ) = ( 1 - {x}^{2} ) ;$$

$$w ( x - 1 ) = \frac{{x}^{2} + x}{2} .$$

This assumes three data point values.

For a cubic interpolation, starting from four data point values, formula

$${y}_{x} = ( {w}_{- 1} ( x ) {z}_{0}^{+ 1} {y}_{- 1} + {w}_{0} ( x ) {y}_{0} + {w}_{1} ( x ) {z}_{0}^{- 1} {y}_{1} + {w}_{2} ( x ) {z}_{0}^{- 2} {y}_{2} ) {z}_{0}^{x} \qquad ( III )$$

is in particular suitable, wherein the weighting factors

$${w}_{- 1} ( x ) = \frac{( 2 - x ) ( x - 1 ) x}{6}$$

$${w}_{0} ( x ) = \frac{( x - 2 ) ( x - 1 ) ( x + 1 )}{2}$$

$${w}_{+ 1} ( x ) = \frac{( 2 - x ) x ( x + 1 )}{2}$$

$${w}_{+ 2} ( x ) = \frac{( x - 1 ) x ( x + 1 )}{6}$$

can be used.

The distance between successive data point values is, in particular, a constant unit distance, regardless of the order of the interpolation. The bandwidth limitation of the analytical signal can be achieved using a bandpass filter known per se.

The processing of the analytically complex, band-limited signal used for interpolation preferably includes suppression of the negative frequency components before the interpolation, that is, complex Hilbert filtering.

The signal to be processed can already be present as a complex-valued signal. Alternatively, it is possible to calculate the analytically complex signal from a real-valued input signal. In this case, the imaginary part of the signal can be obtained by a Hilbert transform. This means that the imaginary part is the Hilbert transform of the real part.

The interpolation can be carried out with at least two data points for each interpolated value. The interpolation order is preferably cubic or higher, wherein an odd order is preferred in all cases. Regardless of the type of interpolation, which always happens with complex numbers, it is possible to provide interpolation values as real-valued linear combinations of a real and an imaginary part. An extreme case of such a combination is the omission of the imaginary part, that is, further processing of only the real part.

In principle, interpolation can be carried out using any algorithm. For example, the interpolation is carried out as a Lagrange interpolation. The data point values can be weighted in various ways and included in the interpolation. Apart from the cases already explained, in particular the formula

$$w ( x ) = \frac{sin π x}{π x} ,$$

that is, a sinc function, can be included in the weighting. The sum of all weights during interpolation always equals one.

The signal processing system comprises a signal provision device which is configured to output an analytically complex, bandwidth-limited signal. The origin of this complex signal is irrelevant to the feasibility of the method.

The signal processing system further comprises a device generally referred to as a signal processing device, which includes a frequency setting device and an interpolation device, wherein the functions of frequency setting and interpolation are not necessarily implemented by means that can be physically distinguished from one another.

In any case, the frequency setting device is provided for specifying a reference frequency lying within the bandwidth of the analytical signal, which determines a constant reference phase advance per unit distance of successive sample values, that is, data point values, of the analytical signal. In the simplest case, the reference frequency is in the middle of the frequency band of the complex analytical signal. Finally, the interpolation device is configured to generate at least one value that interpolates the data point values at a predetermined location. At least one of the formulas already listed in connection with the signal processing method is used here.

The interpolation device can in particular be part of a beamforming device which is configured to time shift individual signal channels before their summation.

The signal providing device is, for example, a signal receiving device provided for receiving measurement signals, in particular echo signals. The received signals can be electromagnetic waves, for example, in particular radar signals or optical signals, or mechanical vibration signals, in particular in the form of ultrasound signals.

Embodiments can also be implemented in which the signal providing device is configured for transmission beam forming. In this case too, the signals to be processed can in particular be electromagnetic or acoustic waves.

A particular advantage of the invention is that the interpolation carried out with complex numbers is characterized by a particularly favorable ratio between the computational effort and the accuracy that can be achieved. This makes it possible to subject very high data rates to pre-processing, including interpolation, before the data is processed further digitally. One of the key factors for the precision that can be achieved is the small time offset between the signal pickup at each data point and the interpolation. A serious advantage compared to conventional interpolation methods is achieved in that a reference time, which represents a starting point for time determinations, lies within the time interval in which the data point values lie on which the interpolation is based. This has the advantage of not having to calculate the phase of the reference signal over the entire signal duration, but only over the area of the data points used for the interpolation. This avoids extremely large phase values, which would lead to the loss of many valid digits, in particular when calculating the angle functions sin and cos.

### BRIEF DESCRIPTION OF THE DRAWINGS

Multiple exemplary embodiments of the invention are explained in more detail below with reference to a drawing. Wherein:

FIG. 1 shows a block diagram of the structure of a system for processing analytical signals present at data points,

FIG. 2 is a representation analogous to FIG. 1 showing another signal processing system configured to process analytical signals present at data points,

FIG. 3 shows another embodiment of a signal processing system, in this case with multiple channels, in a representation analogous to FIGS. 1 and 2,

FIG. 4 shows a diagram of fundamental differences between the error behavior of a system according to FIGS. 1 to 3 on the one hand and an unclaimed comparative example on the other hand,

FIG. 5 shows, in the form of a diagram, changes including a phase advance of a signal present at data points and which can be processed with one of the systems according to FIGS. 1 to 3,

FIG. 6 shows, in the form of a three-dimensional diagram, the signal present at each data point according to FIG. 5 and an interpolated value,

FIG. 7 is another diagram showing a weighting factor which is to be used when determining the interpolated value according to FIG. 6 as part of a cubic interpolation.

Unless otherwise stated, the following explanations refer to all exemplary embodiments. Components that correspond to one another or have the same effect in principle are marked with the same reference numerals in all figures.

### DETAILED DESCRIPTION OF THE INVENTION

A signal processing system, designated overall by reference numeral 1, comprises a signal providing device 2 and a signal processing device designated overall by 3. The signal processing device 3 in turn comprises a frequency setting device 4 and an interpolation device 5. Information supplied by the signal processing device 3 is transmitted to a signal processing device 6.

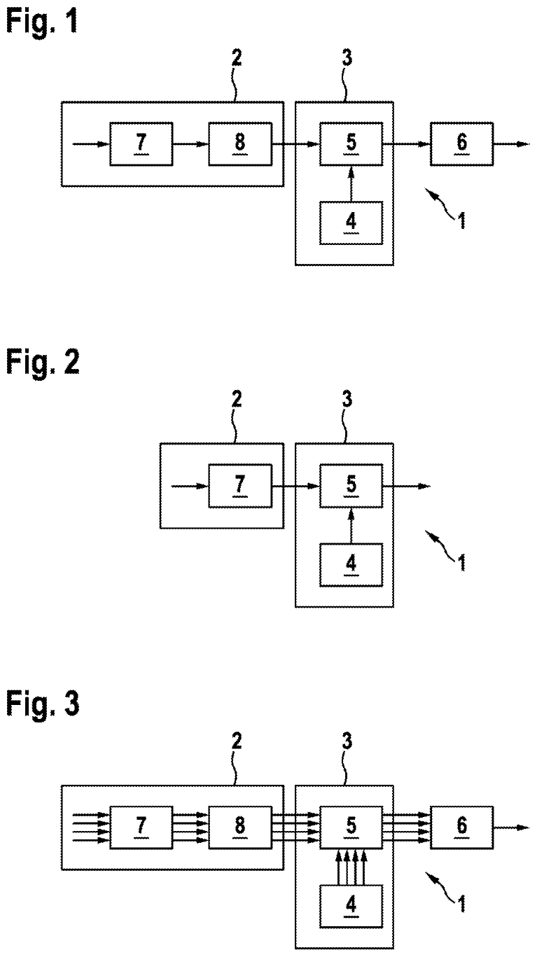

The structure of the signal processing system 1, which is present in various configurations and is outlined in FIGS. 1 to 3, serves to explain the underlying concept and does not imply any statement about the physical division of the system 1 in question into individual components 2, 3, 4, 5, 6. In particular, components 2, 3, 4, 5, 6 shown separately in the figures can be combined into functional units. Conversely, the function of a single component 2, 3, 4, 5, 6 can also be implemented by a plurality of subcomponents, which can be spatially separated from one another. The flow of information is illustrated by arrows in the figures.

In all exemplary embodiments, the signal providing device 2 is configured to output an analytical, that is to say complex, signal. In the exemplary embodiments according to FIGS. 1 and 3, it is assumed that there is initially a real-valued input signal. With the help of a bandpass filter 7, which is assigned to the signal providing device 2, a bandwidth-limited signal is initially generated from this. From this signal, the complex, bandwidth-limited signal required for further implementation of the method is generated by means of a Hilbert filter 8, which is also associated with the signal providing device 2.

In contrast to the exemplary embodiments according to FIGS. 1 and 3, the exemplary embodiment according to FIG. 2 assumes the existence of a complex-valued, that is, analytical, input signal. Accordingly, the Hilbert filter is omitted in this embodiment. Instead, in this case, the bandpass filter 7 is used directly to limit the bandwidth of the analytical signal. In all exemplary embodiments, the analytical signal output by the signal providing device 2 is free of negative frequencies.

The signal processing device 3 carries out a Lagrange interpolation, for example, using the interpolation device 5. It is assumed here that the analytical signal supplied by the signal providing device 2 is present at data points. With the help of interpolation, interpolation values are determined which lie between data point values. The interpolation values, like the data point values, are complex values. The frequency used for filtering output by the frequency setting device 4 represents a reference frequency that lies within the bandwidth of the analytical signal output by the signal providing device 2. The reference frequency determines a constant reference phase advance per unit distance of successive sample values, that is, data point values, of the analytical, that is, complex-valued signal.

In the exemplary embodiment according to FIG. 1, the values output by the signal processing device 3, that is, data point values and interpolation values, are generated as complex values, but are only partially further processed. Specifically, in this case, the imaginary part of the values is discarded, whereas the real part is subjected to further processing by means of the signal processing device 6.

In contrast to the exemplary embodiment according to FIG. 1, the values output by the signal processing device 3 in the exemplary embodiment according to FIG. 2 are further processed as complex values, that is to say, with their real and imaginary parts.

In the exemplary embodiment according to FIG. 3, there are a large number of channels for transmitting signals. This already applies to the real-valued input signals, which must first be limited in terms of their bandwidth using a bandpass filter 7 and then converted into analytical signals using a Hilbert filter 8. In the case of FIG. 3, the so-called frequency setting device 4 also processes time shifts between different signals running over different channels. Finally, in the case of FIG. 3, the signal processing device 6 is used for complex signal summation. As in the case of FIG. 2, complex numbers are further processed by the signal processing system 1 in this case as well.

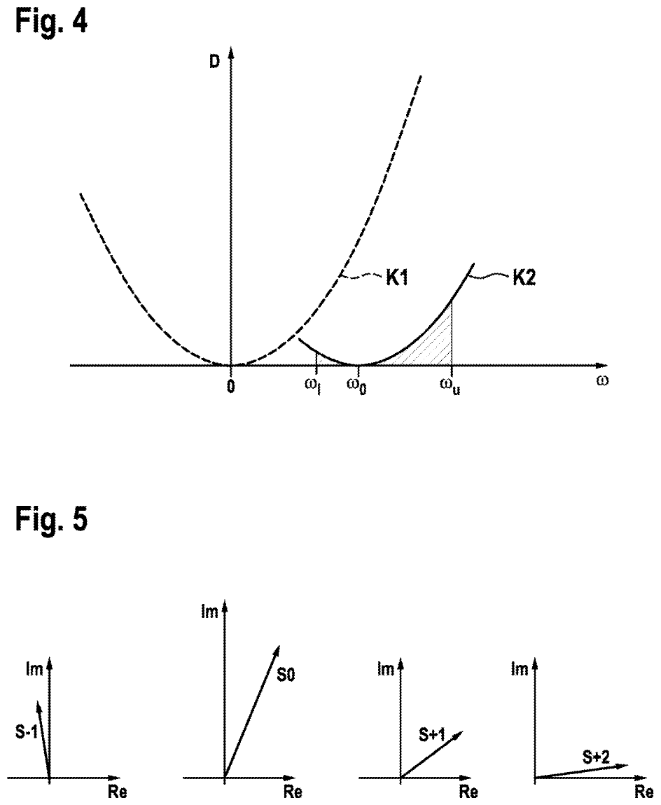

The further the frequency of a signal, whose frequency range of interest extends from ωₗ to ωᵤ, deviates from the frequency zero, the larger the errors that are associated with a usual interpolation (dashed curve K1 in FIG. 4). The amounts of the errors, that is, the deviations between the actual, physical signals and the information obtained through measurement technology, are generally designated by D in FIG. 4.

As can be seen from FIG. 4, the deviation D between the actual signal and the information obtained from the measured values by interpolation increases as a function of frequency, starting from a reference frequency, in the manner of a parabolically rising curve. In standard interpolation, this reference frequency is at frequency zero (curve K1 in FIG. 4).

Such a rise is in principle also present in the signal processing method according to this application. The crucial difference to the rise outlined by the dashed curve K1 is that in the method according to the application the reference frequency ω₀ can be chosen arbitrarily. In particular, this makes it possible to reduce the interpolation error in the area of interest. Near the reference frequency ω₀, the error D is small, such that it is particularly advantageous to choose the reference frequency ω₀ within the frequency range of interest, for example in its center (curve K2 in FIG. 4).

The increase in deviation D is illustrated in FIG. 4 by a dashed area and can be compared to the area below the dashed curve K1, which is in the same frequency range and is not marked in this diagram. This comparison shows that the deviation D is largely or completely avoided—namely at ω₀—by the method according to the application.

A known alternative method mixes the specified frequency band towards zero frequency in order to also achieve a reduction in the interpolation error. This requires an artificial reference frequency, the phase of which can assume arbitrarily large values over time and must be taken into account in further data processing. The reference frequency typically comes from an oscillator whose frequency is not exactly stable.

In the signal processing method according to the application, on the other hand, the risk of the actually introduced reference phase on the one hand and the expected reference phase on the other hand drifting apart is fundamentally excluded.

As far as the change in the phase of the analytical signal, which is recorded at each data point, is concerned, reference is made to FIG. 5. It is assumed from four data points, that is, four signals S₋₁, S₀, S₊₁, S₊₂. While the magnitude of the signal changes significantly from data point to data point, the phase advance, as illustrated in FIG. 5, can be assumed to be constant. The signal S₀ is used as the time base for the interpolation, wherein an interpolated value to be calculated lies in the interval between S₀ and S₊₁ and the interpolation is carried out as a cubic interpolation.

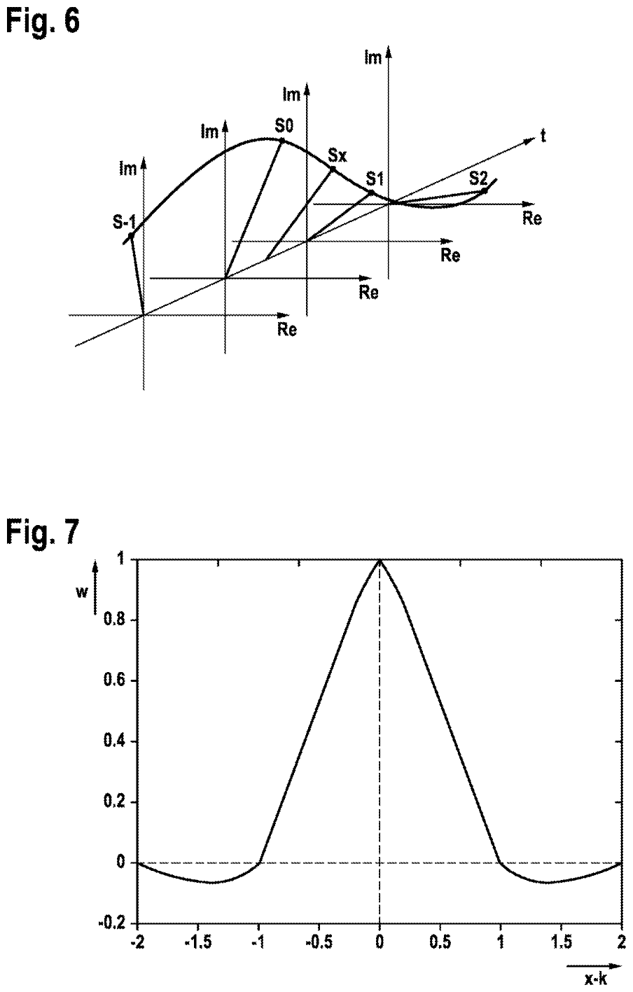

The signals S₋₁, S₀, S₊₁, S₊₂ shown individually in FIG. 5 are inserted into a three-dimensional diagram in FIG. 6, which includes the time axis. Furthermore, an interpolated signal value Sₓ is inserted in FIG. 6. The various measured signals S₋₁, S₀, S₊₁, S₊₂ and in this case the only interpolated signal Sₓ describe a modified screw shape, as shown in FIG. 6.

In FIG. 7, the weighting factor w is plotted, with which the data point values S₋₁, S₀, S₊₁, S₊₂ are weighted into interpolation. Four adjacent areas, each with a width of one, can be clearly distinguished from one another. If the value to be interpolated was based on an actual measured value, the weighting factor for this would be 1.0, otherwise only zero weightings would occur. This means that the actual measured value is taken over as an interpolated value, that is, there is no actual interpolation. In all other cases, the amount of each individual weighting factor is less than one, wherein both positive and negative weighting factors are typically present and the sum of all weighting factors always is one. The four sections of the curve arranged side by side in FIG. 7, which represent the weighting factor w, correspond to the factors w₋₁(x), w₀(x), w₊₁(x), w₊₂(x) already listed in connection with the cubic interpolation and, as can be seen from FIG. 7, are connected to each other in a non-differentiable manner.

### LIST OF REFERENCE NUMERALS

1 Signal processing system
2 Signal providing device
3 Signal processing device
4 Frequency setting device
5 Interpolation device
6 Signal processing device
7 Bandpass filter
8 Hilbert filter
D difference
k natural number, number of data points
K1 curve in FIG. 4, unclaimed variant
K2 curve in FIG. 4, variant according to the application
S analytical signal
w weighting factor
x index offset
y Measured value or interpolated value
z rotator
τ sampling step size
ω angular frequency

1. A method for processing signals, comprising the following steps:
providing an analytically complex, bandwidth-limited signal,
specifying a reference frequency within a bandwidth of the signal,
detecting data point values yₖ of the signal, wherein a distance between successive data point values is given by a constant reference phase advance predetermined by the reference frequency,
generating at least one interpolation value y(x) at a predetermined point between k successive reference point values yₖ according to the general formula:
$$y ( x ) = {z}_{0}^{x} {\sum }_{k} w ( x - k ) {z}_{0}^{- k} {y}_{k}$$
with z₀=e^{1ω}^{₀}^{τ} as a unit rotator and w as a weighting factor, wherein τ is a sampling step size.

2. The method according to claim 1, wherein the interpolation using the formula:
$${y}_{k} = \{ ( 1 - x ) {y}_{0} + x {z}_{0}^{- 1} {y}_{1} \} {z}_{0}^{x} \qquad ( I )$$
takes place as a linear interpolation.

3. The method according to claim 1, wherein the interpolation using the formula:
$${y}_{x} = \{ \frac{{x}^{2} - x}{2} {z}_{0}^{+ 1} {y}_{- 1} + ( 1 - {x}^{2} ) {y}_{0} + \frac{{x}^{2} + x}{2} {z}_{0}^{- 1} {y}_{1} \} {z}_{0}^{x} \qquad ( II )$$
takes place as a quadratic interpolation.

4. The method according to claim 1, wherein the interpolation using the formula:
$${y}_{x} = ( {w}_{- 1} ( x ) {z}_{0}^{+ 1} {y}_{- 1} + {w}_{0} ( x ) {y}_{0} + {w}_{1} ( x ) {z}_{0}^{- 1} {y}_{1} + {w}_{2} ( x ) {z}_{0}^{- 2} {y}_{2} ) {z}_{0}^{x} \qquad ( III )$$
takes place as a cubic interpolation, wherein
$${w}_{- 1} ( x ) = \frac{( 2 - x ) ( x - 1 ) x}{6}$$
$${w}_{0} ( x ) = \frac{( x - 2 ) ( x - 1 ) ( x + 1 )}{2}$$
$${w}_{+ 1} ( x ) = \frac{( 2 - x ) x ( x + 1 )}{2}$$
$${w}_{+ 2} ( x ) = \frac{( x - 1 ) x ( x + 1 )}{6}$$
are used as weighting factors.

5. The method according to claim 1, wherein the distance between successive data point values is a constant unit distance.

6. The method according to claim 1, wherein the analytically complex, band-limited signal used for interpolation is processed by suppression of negative frequency components before the interpolation, comprising complex Hilbert filtering.

7. The method according to claim 1, wherein the analytically complex signal is calculated from a real-valued input signal.

8. The method according to claim 1, wherein the interpolation values comprise linear combinations of a real part and an imaginary part.

9. The method according to claim 8, wherein only the real part of the complex interpolation values obtained is further processed.

10. A signal processing system, with a signal supply device which is configured to output an analytically complex, bandwidth-limited signal, and with a signal processing device which comprises a frequency setting device and an interpolation device, wherein the frequency setting device is configured to specify a reference frequency lying within a bandwidth of the analytical signal, which reference frequency determines a constant reference phase advance per unit distance of successive sample values, comprising data point values, of the analytical signal, and the interpolation device using the general formula:
$$y ( x ) = {z}_{0}^{x} {\sum }_{k} w ( x - k ) {z}_{0}^{- k} {y}_{k}$$
is configured to generate at least one value that interpolates the data point values at a predetermined location, wherein z₀=e^{1ω}^{₀}^{τ} denotes a standard rotator, w denotes a weighting factor, and τ denotes a sampling step size.

11. The signal processing system according to claim 10, wherein the interpolation device is configured to apply the weighting formula
$$w ( x ) = \frac{sin π x}{π x} .$$

12. The signal processing system according to claim 10, wherein the interpolation device is part of a beamforming apparatus which is configured to time shift individual signal channels before summation.

13. The signal processing system according to claim 10, wherein the signal supply device is configured as a signal receiving device for receiving measurement signals.

14. The signal processing system according to claim 10, wherein the signal supply device is configured for transmission beamforming.

15. The signal processing system according to claim 10, wherein the signal supply device is configured as a signal receiving device for receiving echo signals.
